(19) United States
(12) Patent Application Publication
(10) Pub. No.: US 2025/0000018 A1
(43) Pub. Date: Jan. 2, 2025

(54) Thrust-Driven Motion Vegetation Cutting Device And Method For Controlling The Same

(71) Applicant: Dennis Matthew Kave, Henrico, VA (US)

(72) Inventors: Dennis Matthew Kave, Henrico, VA (US); Tyler Matthew Kave, Henrico, VA (US); Lauren Anne Kave, Henrico, VA (US)

(73) Assignee: Dennis Matthew Kave, Henrico, VA (US)

(21) Appl. No.: 18/701,204

(22) PCT Filed: Nov. 3, 2022
(86) PCT No.: PCT/US22/79191

§ 371 Date: Apr. 12, 2024

Related U.S. Application Data
(60) Provisional application No. 63/360,861, filed on Nov. 5, 2021.

(51) Int. Cl. A01D 34/74; A01D 34/66; A01D 34/68; A01D 34/78

(52) U.S. Cl. CPC A01D 34/74; A01D 34/66; A01D 34/68; A01D 34/78

(57) ABSTRACT

A vegetation cutting device comprises at least one motor/blade assembly comprising a motor and a blade supported for rotational movement in relation to the motor. The blade is curved to provide airflow thrust to produce at least one of vertical or orbital motion of the blade.

### CROSS-REFERENCE TO RELATED APPLICATIONS

This application claims priority to U.S. Provisional Patent Application No. 63/360,861, filed on Nov. 5, 2021, and is a Continuation-in-Part of International Patent Application No. PCT/2020/054503, filed Oct. 7, 2020, which claims priority to U.S. patent application Ser. No. 17/064,176, filed Oct. 6, 2020, and U.S. Provisional Application No. 62/973,660, filed Oct. 17, 2019, the disclosures of which are incorporated herein by reference in their entirety.

### BACKGROUND

This invention relates in general to equipment for cutting vegetation, and more particularly, lawn mowers.

There has been a sea change in equipment with immense potential for innovation and opportunity to bring more efficient, cleaner and safer landscaping equipment to market. Electrification of vegetation cutting machines, such as lawn mowers, is an area of significant opportunity given that fundamental properties of basic electric components provide natural advantages over internal combustion engine (ICE) mowers. For example, electric motors fitted with blades can be positioned directly in the cutting plane to rotate and cut the grass without the need for energy translation, which is required in ICE mowers where linear motion of pistons must be translated into rotational motion with additional translation via belt-driven rotation in the case of multi-rotor decks. Also, since electrical wires are flexible, electrical energy can be transferred to the motors without a fixed transmission. In other words, an electric motor with a rotating blade connected to a power source via wires can translate and rotate in three dimensions limited only by the length and flexibility of the wire and the mechanical constraints engineered into the host frame. Therefore, the engineering design challenge is to configure the host framework to harvest these inherent advantages. With direct-drive electrification and appropriate configurations, the motor/blade assemblies can be dynamic and use the mower blade aerodynamic properties with resulting vectors of thrust/lift (suction) to help achieve desired motion and a 3D position of the blade and help control the overall stability of the vegetation cutting device overall.

One of the main challenges with cordless electric mowers is how to budget the limited battery pack power to achieve a quality cutting job. As with everything in engineering, there are tradeoffs that need to be made. Given high unit cost and weight of rechargeable batteries needed to power mowers for large commercial areas, it is clear that there's immense opportunity in designing more efficient configurations that can be scaled as an optimal template for manufacturers to use. Designers need to leverage every possible opportunity to save energy while producing safe/quality results that meet expectations of the customer.

Pursuit of a universal mower is a 3D problem to solve (mowing is off-road on rolling surfaces, heterogeneous terrain, variable obstacles, resulting variable loads/stresses), but current solutions are designed as 2D surface machines with human muscle and manual manipulation extending the solutions into 3D.

Fields of grass represent a heterogeneous load for the motor/blade assemblies. Given a constant forward velocity of the electric mower, as the grass height and thickness increases, the load resistance to cutting increases, which increases the load on the motor, causing a downward spiral in both cut quality and electrical system performance/efficiency, resulting in a slower RPM of the cutting blade, degrading cut quality (most notably uncut grass left behind likely requiring at least one more mowing pass), accelerated amp draw from the battery as the motor tries to maintain the target RPM at the rated voltage, excessive heating of motor windings given higher amps, and stressed/heated electronic components including the battery. As forward movement of the mower continues in the tall grass, the RPM will likely continue to lower, further degrading cut quality, including an even higher proportion of uncut grass, torn grass and burned grass (given blade surface friction rubbing over uncut grass). This results in further heating motor and electrical components, eventually leading to the complete stall of the motor (requiring re-start).

Obviously, this isn't an optimal circumstance and leads to a combination of poor cut quality requiring the operator to return to the cutting area to address uncut grass where RPM's were too low, grass damage that may require re-seeding, stressed motor components leading to shortened product life, and shortened battery run-time per charge as the stall spiral simultaneously discharges the battery at a high rate while the grass isn't being adequately cut (requiring re-work).

At scale, this combination of inefficiencies is costly from both a labor and equipment perspective, and the proposed devices and methods offer a more efficient novel solution.

### SUMMARY

This invention relates to configurations that leverage thrust-based forces derived from mower blade aerodynamic surfaces as control inputs to the motion and position of the blade in three-dimensional space. Properly configured, the invention results in solutions that provide: a thrust-enabled continuously variable cutting height with top-down mulching, a mower configuration that allows an electric motor/blade assembly to move up and down relative to the ground (z-axis), a thrust derived from aerodynamic surfaces of curved mower blades that causes force vectors in the z-axis with resulting up and down motion of the motor/blade assembly, and use of mechanical springs (including spring washers, torsion springs, shock absorbers, elastic materials exhibiting spring-like behavior, etc.) to oppose the thrust-based force vectors as a dampener to limit motor/blade assembly vertical range of motion in the z-axis, and a range of motion is calibrated to specific property and grass specifications. At maximum height, starting power is in the OFF position, with no thrust acting in the z-axis. The motor/blade assembly is suspended by a spring or combination of springs. The spring properties (spring type, linear vs. non-linear, size, k-factor (i.e., spring constant), and initial compression distances) are calibrated to suspend the motor/blade assembly at maximum height while in the power OFF position. One side of the spring is attached to the mower frame (fixed in the vertical z-axis) with the other side attached to the motor/blade assembly mount. Maximum height is calibrated to the property at a level at or near the current height of the uncut grass (i.e., five inches). This establishes the maximum height as approximately the no load from grass resistance position for the motor/blade assembly. At minimum height, a desired grass cutting height (i.e., 3.5 inches), the minimum height represents the vertical floor of the motor/blade assembly.

Various advantages of this invention will become apparent to those skilled in the art from the following detailed description of the preferred embodiment, when read in light of the accompanying drawings.

### BRIEF DESCRIPTION OF THE DRAWINGS

FIG. 1 is a partially cutaway side elevational view of an exemplary mower configuration.

FIG. 2 is a partial view of the mower shown in FIG. 1, showing different positions of a mower blade at different phases of operation.

FIG. 3 is a side elevational view of an exemplary orbital mower configuration.

FIGS. 4A and 4B are partial views of the mower shown in FIG. 3, showing different angular positions of a mower blade.

FIG. 5 is an enlarged side elevational view of a relevant part of the mower shown in FIG. 3, showing a connection for supporting the blade at different angular positions.

FIG. 6 is a front elevational view of the mower shown in FIG. 3, operated on a slope.

FIG. 7 is a perspective view of a motor/blade assembly with a louvered cover for creating thrust to move the motor/blade assembly.

### DETAILED DESCRIPTION

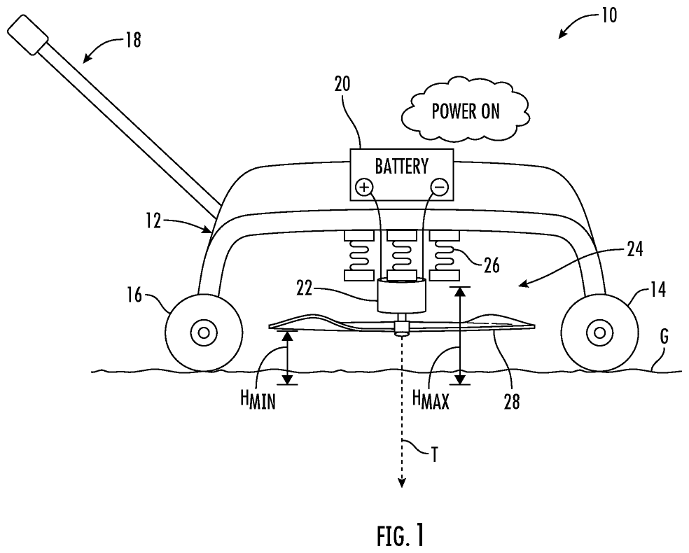

Referring now to the drawings, there is illustrated in FIG. 1 an exemplary mower 10 comprising a mower frame 12 supported for movement in relation to a supporting surface (i.e., the ground G) by wheels, including, for example, front and rear wheels 14, 16. A mower handle 18 may be provided for pushing the mower 10 along the ground G. The mower frame 12 may support a power source (e.g., battery 20), which may provide power to an electric motor 22 of a motor/blade assembly 24, which may be supported in relation to the mower frame 12 by mechanical springs 26 (including spring washers, torsion springs, shock absorbers, elastic materials exhibiting spring-like behavior, etc.). The electric motor 22 drives a mower blade 28. It should be understood that the mower 10 may comprise a plurality of mower/blades assemblies 24. It should be understood that the mower 10 may comprise and a single spring 26.

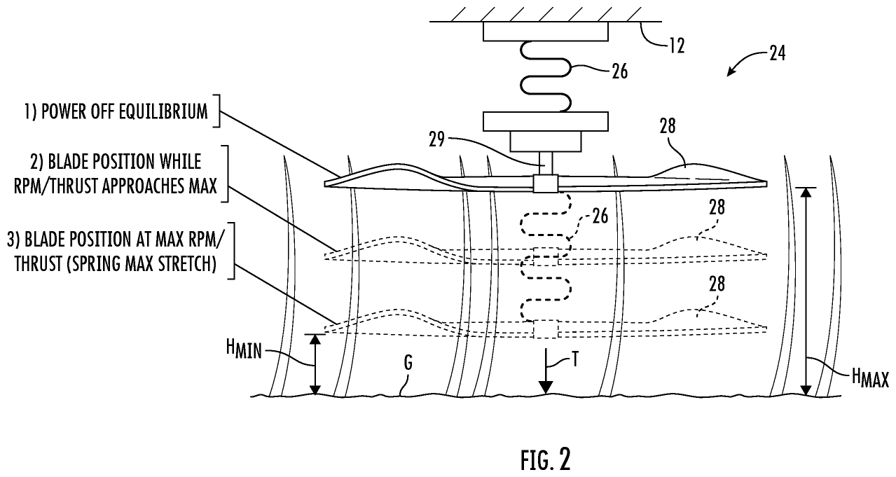

FIG. 2 illustrates a representation of a general proposed mower configuration, illustrating integration of the motor/blade assembly power, forces and motion. The motor/blade assembly 24 starts with the mower blade 28 at a maximum height Hₘₐₓ (e.g., five inches) with the electric motor 22 powered OFF. When powered ON, the electric motor 22 rotates the mower blade 28 (e.g., via shaft 29). The mower blade 28 is preferably curved, in the direction that creates thrust downward toward the ground G (in the direction of arrow T). Air flows from the ground G upward through the mower blade 28, lifting the grass (and other vegetation, leaves, sticks, debris) toward the mower blade 28. This is the typical airflow with curved lifting blades.

Varying levels of mower blade curvature can be used to create desired airflow to provide suction to lift uncut grass so the blade makes contact with the cut grass, provide continuous suction to keep clippings above the rotating blade to mulch the grass into fine pieces, and blow the clippings out of a side discharge or suck clippings into a bagger. Just as with helicopter or Unmanned Aerial Vehicle (UAV) drones, the more pitched the blade, the more airflow is created or provided, in adherence with basic aerodynamic principles. The curved part of mower blades mirrors the curvature of helicopter/drone blades (but upside-down so the thrust vector is pointed down). The thrust derived from the airflow around the curved mower blades is used to cause actual kinetic motion of the mower 10 along defined degrees of freedom of the mower 10 versus using the airflow solely for motion of the grass clippings (i.e., lifting/transporting/circulating/disposing of the grass clippings).

The present invention harnesses inherent mower blade airflow/thrust to cause useful kinetic motion of the mower 10. The instant invention may be used in conjunction with the invention disclosed in U.S. Pat. No. 11,058,052, which issued on Jul. 13, 2021, to Dennis Matthew Kave, the disclosure of which is incorporated herein by reference in its entirety, where inherent motor/mower blade angular momentum is harnessed to generate useful kinetic motion of the device. The combined usage of motor/blade angular momentum and thrust can be compared to the operation and control of UAV drones (i.e., quadcopters).

Now referring back to FIG. 2, operation of the motor/blade assembly 24 will be described in more additional detail. As the motor/blade assembly 24 increases RPM and approaches a design-specified continuous RPM, the thrust T increases in proportion to the square of the blade RPM (which requires testing to verify a specific relationship in each configuration). The force of the thrust T opposes resistance forces of springs 26, causing the motor/blade assembly 24 to travel downward to approach a minimum height Hₘᵢₙ (e.g., three inches). As the motor/blade assembly 24 travels downward given increasing thrust T, the springs 26 apply opposing forces (potentially in a non-linear fashion) to limit the travel of the motor/blade assembly 24 to the minimum height Hₘᵢₙ. At the minimum height Hₘᵢₙ, the motor/blade assembly 24 can be modeled as in a static framework from the perspective of the z-axis (i.e., a vertical axis) with the sum of the weight W of the motor/blade assembly 24 and the maximum design thrust T equal to the net spring/spring-like force/elastic strain F acting along the z axis (W+T=F). To ensure that proper grass cutting height is achieved and that grass is not scalped (cut too low), spacers (e.g., spacers/casters below the center of the motor/blade assembly 24 to guard against blade-to-ground contact) can be used under the motor/blade assembly 24 to resist movement below the minimum height Hₘᵢₙ. As the motor/blade assembly 24 progresses from maximum height Hₘₐₓ to minimum height Hₘᵢₙ, the cutting blades 28 experience variable resistance given variable grass height, thickness and other yard debris, such as sticks and leaves. As the overall lawn-based resistance to blade rotation increases, the blade rotation RPM slows and thrust T decreases in proportion to a decrease in RPM. Eventually, the thrust T is completely counterbalanced by a net spring force upward, which stops the downward motion followed by slight upward motion away from the zone of grass resistance where the blade 28 can resume a design RPM and a design thrust T. The cycle of acceleration to design RPM, thrust dominance (i.e., effects of thrust T pulling on the springs 26) downward motion, grass resistance slowing RPM, lower thrust, spring dominance (i.e., effects of springs 26 pulling on the blade 28) upward motion out of zone of grass resistance, acceleration to design RPM, etc. increases. The cycle results in gradual top-down cutting as the cutting blade gradually progresses downward to the minimum height Hₘᵢₙ.

The practical result of this top-down mulching is relatively small grass cuts (digestible to soil) produced within an RPM band that facilitates quality cutting with minimal strain on the electrical system (e.g., battery 20, electric motor 22, wiring, etc.). The RPM fluctuation, resulting thrust fluctuation and offsetting spring force fluctuation, will result in a visual floating/oscillating motor/blade assembly 24 as the blade 28 gradually travels downward toward minimum height Hₘᵢₙ, leaving quality gradual small grass cuts spread throughout the cutting region.

It should be appreciated that top-down mulching capability will benefit the most from efficiencies derived from thrust-enabled, continuously variable cutting height with top-down mulching include self-propelled electric push mowers, off-the-shelf robotic lawn mowers, and orbital deck mowers.

Integration of this technology with the forward speed of the self-propelled mower will help optimize the cut quality, time spent re-mowing the same area, and battery life efficiency, while also minimizing stress on the electrical components, thereby increasing the useful life of all components (reducing downtime and maintenance costs). This can be done in any suitable manner, such as by attaching a sensor to determine the extension of the spring with logic in a wheel motor controller that allows faster forward movement as the spring extends. An exemplary sensor would be a linear potentiometer connected between the fixed and moveable part of the device (i.e., mower), for example, running through the center of the spring.

Integration of this technology with the forward drive logic in currently available robotic lawn mowers will help optimize the cut quality and battery life efficiency, while also minimizing stress on the electrical components, thereby increasing the useful life of all components (reducing downtime and maintenance costs).

Note that currently available robotic lawn mowers operate on the principle of making multiple passes over the grass to gradually complete the job. One of the main reasons that multiple passes are required over the same grass region is that the grass is not effectively cut on the first pass, clearly posing an opportunity for improvement that this technology can help address. This technology will also allow many of the current robotic mowers to mow taller grass since many robotic mowers cannot start mowing if grass starts too tall/thick given that the grass resistance impedes the ability of the small motors to generate enough torque to start cutting (starting stall leaving landowner no choice other than to mow with non-robotic product for the initial mow because the robot simply cannot do it).

Orbital deck mowers benefit from this technology by providing an optimized combination of success factors critical for high quality and highly efficient lawn mowing. Basic key success factors of traction, geometry, balance, rotational kinematics, basic electricity, electronics, and aerodynamic thrust/lift (using this technology) work simultaneously in a mutually reinforcing natural cadence to deliver optimal results.

An example of an orbital deck mower, currently in development, is described in U.S. Pat. No. 11,058,052, issued Jul. 13, 2021, to Dennis Matthew Kave, the disclosure of which is incorporated herein by reference in its entirety. Orbital deck mowers can leverage thrust-driven motion control technology in multiple dimensions and ranges of motion, including continuously variable cutting height, top-down mulching, and additional optional thrust-based motion. There is a potential for scalable universal application with ability to successfully traverse all relevant terrain/grades and position the rotating blade in the optimal 3D location to promote successful execution of a quality mow.

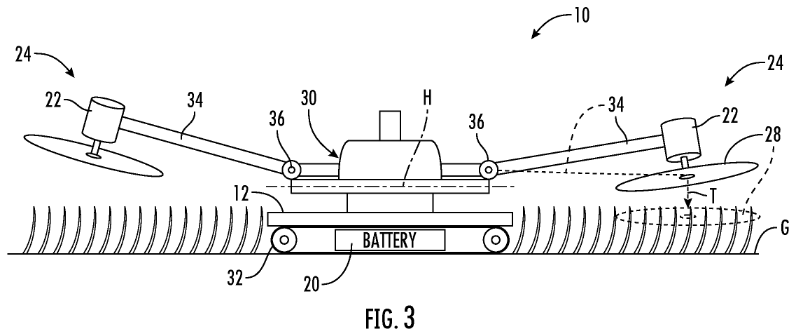

A specific application of invention with an orbital deck mower 10, including thrust-enabled, continuously variable cutting height with top-down mulching, is described with reference to FIG. 3, wherein the configuration of the mower 10 allows the electric motor/blade assembly 24 to move up and down relative to the ground G (e.g., along a z-axis). Thrust derived from aerodynamic surfaces of curved mower blades 28 causes force vectors along the z-axis with resulting up and down motion of the motor/blade assembly 24. The mechanical springs 36 (e.g., spring washers, torsion springs, shock absorbers, elastic materials exhibiting spring-like behavior, etc.) oppose the thrust-based force vectors as a dampener to limit motor/blade assembly 24 vertical range of motion along the z-axis. Range of motion is calibrated to specific property and grass specifications with a maximum height Hₘₐₓ, starting in the powered OFF position, with no thrust acting in the z-axis. Each of the two or more orbital shafts 34 (that suspend the motor/blade assembly 24) are directly or indirectly suspended by a mechanical spring or spring hinge 26 (including spring washers, torsion springs, shock absorbers, elastic materials exhibiting spring-like behavior, etc.) or a plurality or combination thereof. Spring properties (spring type, linear vs. non-linear, size, k-factor (i.e., spring constant), and initial compression distances) are calibrated such that the orbital shaft lift angle that suspends the motor/blade assembly 24 is at maximum height Hₘₐₓ while in the powered OFF position. One side of the spring 36 is attached to the orbit mower central rotating turret 30 (fixed in the vertical z-axis) with the other side attached to a proximal end of each of the two or more orbital shafts 34 (with motor/blade assembly 24 mounted on the distal end of the shaft 34). The maximum height Hₘₐₓ is calibrated to the property at a level at or near the current height of the uncut grass (i.e., five inches). This establishes the maximum height Hₘₐₓ as approximately the no load from grass resistance position for the motor/blade assembly 24. The minimum height Hₘᵢₙ is the desired grass cutting height (i.e., 3.5 inches), which represents the vertical floor of the motor/blade assembly 24.

FIG. 3 illustrates a general proposed mower configuration, for general stages of thrust-enabled, continuously variable cutting height with top-down mulching capability, in the form of thrust-enabled orbital motion. The motion is achieved by an orbital deck mower 10 comprising a rotating turret 30 supported by a mower frame 12 that is supported for movement in relation to a supporting surface (i.e., the ground G) by treads 32 (driven by a suitable motive force, controlled by a suitable control device). A power source (e.g., battery or batteries 20), which is supported in relation to the mower frame 12, provides power to the motor/blade assembly 24, and more particularly, to electric motors 22 that drive the mower blades 28. The motor/blade assembly 24 is connected to the rotating turret 30 by orbital shafts 34, via a spring hinge 36. The mower blades 28 include curved aerodynamic surfaces. The motor/blade assembly 24 is angularly adjustable by rotating the assembly 24 about an axis of the shafts 34. This creates a component of thrust vector providing thrust tangential to the orbit of the machine (i.e., the mower), which effectively accelerates the rotation of the mower frame 12 in the direction of the thrust T. The magnitude of the thrust component T_{comp} will be approximately equal to the product of total thrust Tₜₒₜₐₗ and the cosine of the angle of tilt relative to the plane of rotation Θₜᵢₗₜ (T_{component}=Tₜₒₜₐₗ*cosine Θₜᵢₗₜ). In planning and controlling orbital direction, angular velocity and angular acceleration, it is important to understand that the resultant motion will combine the impacts of thrust-based angular acceleration and the angular velocity resulting from conservation of angular momentum. By varying control inputs of motor rotational speed (RPM), direction (clockwise (CW) and counterclockwise (CCW)), and Θₜᵢₗₜ, the resulting motion of the mower frame 12 can be engineered to fit the particular application. The resulting tangential thrust component will provide angular acceleration, which interacts with the torque-based angular velocity to either speed or slow the orbital angular velocity of the motor/blade assembly 24. The magnitude and direction of the tilt will be determined based on the needs of the application.

Tangential thrust is the result of the resulting motion of the blade/motor assembly 24 in three-dimensional space, which is the result of combining several vector components, including the weight of the motor/blade assembly 24 and orbital shaft 34, the force of the spring 36, the thrust from the mower blades 28 (if curved), and angular momentum of the mower blades 28 (which may or may not be curved and create thrust). When a motor 22 with a curved blade 28 is positioned on a radius free to rotate around the turret 30, with the blade 28 facing directly downward (i.e., toward a flat surface or ground G), with the motor 22 spinning clockwise, the blade 28 creates thrust downward, and there is no tangential thrust component accelerating the system around the turret 30 (no orbital thrust). The entire motor/blade assembly 24 counter-rotates counter-clockwise from angular momentum at angular velocity prescribed by the Law of Conservation of Angular Momentum. With the motor/blade assembly 24 rotated or tilted slightly so that the blade 28 is tilted toward the ground G (e.g., by 5 degrees) as the motor/blade assembly 24 rotates counterclockwise. This produces a tangential thrust component accelerating the system around the turret 30 in the clockwise direction.

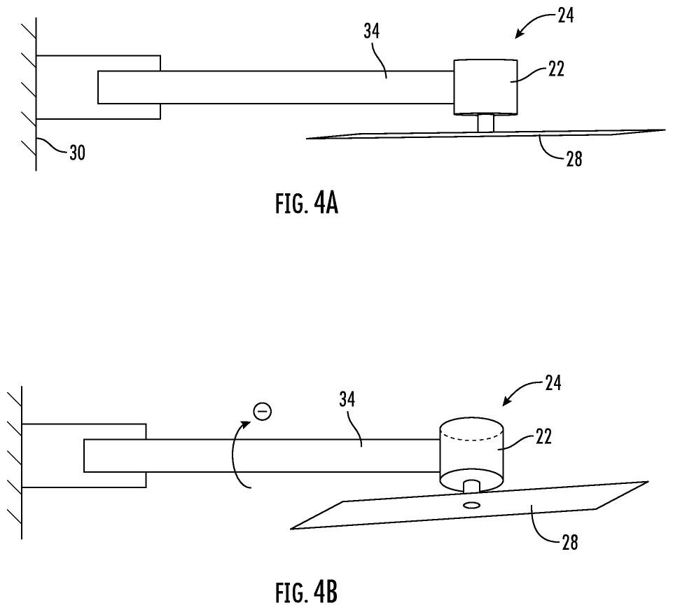

FIGS. 4A and 4B show a simple embodiment of the motor/blade assembly 24 fitted with curved mower blades 28 with aerodynamic surfaces simply tilted/rotated by some angle Θ about the longitudinal axis of the orbital shaft 34. FIG. 4A shows the motor/blade assembly 24 without tilt. FIG. 4B shows the motor/blade assembly 24 tilted (e.g., 10 degrees). In the orbital deck mower described in U.S. Pat. No. 11,058,052, thrust-based orbital motion can be employed by adding curved mower blades mounted with a tilt angle Θₜᵢₗₜ. In order to control variable tilting to suit needs, a servo motor could be used to rotate/tilt the orbital shafts 34 to the desired angle Θₜᵢₗₜ. Also, with the invention described in U.S. Pat. No. 11,058,052, it is possible to employ top-down mulching and thrust-based orbital motion by combining an actuator for raising/lowering the orbital shaft 34 with a curved mower blade 28 and servo motor that rotates/tilts the shaft 34 by some tilt angle Quilt. (refer to FIG. 4 in U.S. Pat. No. 11,058,052). In fully integrated embodiments without mechanical actuators, features of both thrust-based variable cutting height and thrust-based orbital motion may be combined such that the cutting-height position may control the tilt-angle of the motor/blade assembly 24. This can be accomplished in a number of ways.

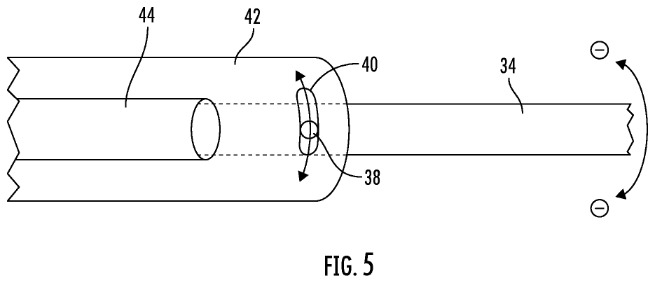

FIG. 5 shows a simple exemplary mechanism for limiting rotation of the orbital shaft 34, which includes a male appendage 38 at the proximal end of the shaft 34 (free to rotate along the axis of the shaft 34) inserted into female slot 40 on a fixed slotted plate or tube 42. The shaft 34 may be supported in relation to a sleeve 44 and may move up and down in relation to the turret 30 (not referenced in FIG. 5) by virtue of movement of the plate or tube 42. As the shaft 34 moves up and down in response to the vertical components of thrust and spring forces in the z-axis, the contact between the male appendage 38 and the female slot 40 forces the shaft 34 to rotate, thereby changing the magnitude and (in some designs) the direction of the tangential thrust component.

In thrust-enabled actuation, thrust-based actuation may raise and lower the motor/blade assembly 24 to achieve the most efficient operation. With thrust-enabled stability control, the motor/blade assembly 24 thrust can be strategically used to optimize control and balance of the mower 10 in challenging circumstances. The thrust-based stability and control on challenging terrain could be combined with thrust-based actuation to direct thrust in direction to maintain stability on steep slopes.

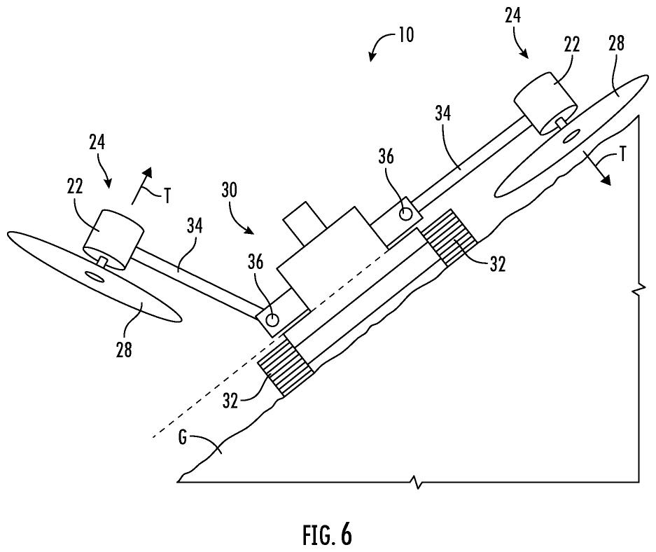

In FIG. 6, application on a steep slope is illustrated, with thrust enabled flight of the entire mower 10. Relocation, via UAV-like (i.e., drone-like) vertical flight, could include a short flight to free the mower 10 from a trapped position or a longer, low-altitude flight to a charging station, etc. Engaging flight-mode would simply involve reversing the rotation direction of the motor 22 to provide thrust upward (versus suction upward to lift the grass) with differential thrust to each motor 22 to navigate the device to the desired location.

It should be understood that spacing thrusters around the driving unit can help stabilize the device, particularly in rough terrain. An exemplary drive unit is disclosed in U.S. Pat. No. 11,058,052. Drive unit stability for a drive unit of this nature and keeping weight on the drive tracks/treads is fundamental for traction, so having exterior thrusters essentially providing suction toward the ground adds downward weight and traction to the drive tracks. Each motor could provide different thrust levels depending on how the terrain is causing the drive unit to lean in different ways. It should be appreciated that reverse thrust on one side, as shown in FIG. 6, could help increase maximum grade as the unit gets close to roll-over.

The range of motion of the shaft 34 will depend upon the configuration needed. Completely folding the shaft 34, as shown in FIG. 6, will not be needed in most applications. The shaft 34 may fold in a range of 0 to 15 degrees more to effectively do the top-down mulching fluctuations. So, upward motion of the shaft 34 may be locked at 15 degrees from horizontal to produce upward thrust. Locking/constraining rotation of the shaft 34 could be done in any suitable manner. This could be accomplished, for example, with slots 40 to insert pins 38, as mentioned above, that could limit rotation of the shaft 34 upward as desired.

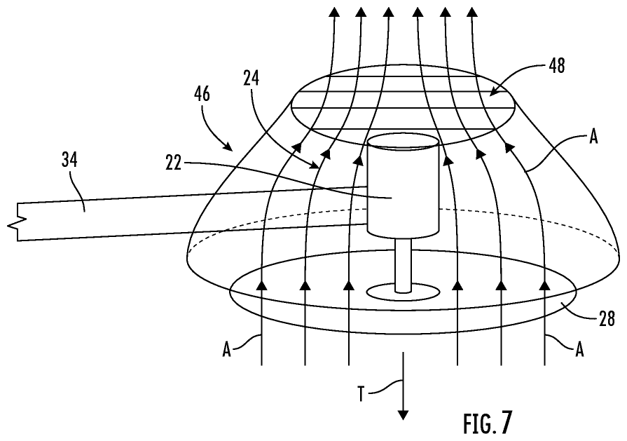

Now referring to FIG. 7, there is illustrated a cover 46 that could provide a basic protective housing around the motor/blade assembly 24. With curved mower blades 28, together with vents 48 in the cover 46, may allow continuous airflow A upward from the ground G and allow an opening for grass clippings to be discharged. The vents 48 can also be louvered at an angle to deflect the airflow A in a manner to cause reactive rotational motion of the mower frame 12 (the vents 48 may effectively act as a sail). As shown in the drawing, the airflow A moves up past the curved mower blades 28, up through the cover 46 and impacts the angled vents (shown at a 45-degree angle), causing the orbital mower frame 12 to rotate. The cover 46 also provides protection. Vents 48 in the cover allow continuous airflow A. The louvered vents 48 allow airflow A to provide additional motion and/or direct grass clipping discharge. Positioning the vents 48 at a 45-degree angle may provide tangential thrust-based force to rotate the turret.

It should be appreciated that the present invention may provide an efficient way to mow grass on a commercial scale via harnessing/harvesting existing available/abundant system energy that is currently wasted/dumped into the device (i.e., mower) bolts, frame, wheels, ground, etc. The configuration of the mowing device to leverage the invention is relatively simple to build. The proposed invention may also provide many additional benefits of balance, stability, safety, reliability, alignment with a global unmanned ground vehicle/unmanned aerial vehicle, ease of maintenance, etc., which may make it a strong candidate to replace myriad specialized mowing products as a general/universal lawn mower configuration, which is probably best suited to be used in a robotic mowing platform. In addition, the ideal configuration and design of future commercial robotic lawn mowing systems using this technology aligns with other large-scale global platforms using unmanned ground vehicle robots, UAV, land mapping, etc., to create efficient operations requiring high certainty across terrains/environments (military, UGV delivery services, drone delivery).

The system energy that is being harnessed/harvested by the present invention goes back to the first principles of physics of energy consumption applied to lawn mowing. Assuming there is a rotating blade/disc parallel to the ground, there are two main energy considerations, energy to rotate the electric blade motor rotor and attached cutting blade(s) (Energy 1) and energy to transport the spinning motor/cutting blade across the surface parallel to ground/grass being cut (Energy 2).

This fundamental energy breakdown highlights the opportunity to leverage angular momentum of the blade motor/blade given angular momentum created as Energy 1 spins the motor/blades essentially creating a flywheel that spins 3000-6000 rpm while cutting the grass. This angular momentum leveraged the angular momentum of the motor/blade ‘flywheels’ from Energy 1 acts in the same plane of motion of Energy 2 so, properly configured, Energy 2 can be harnessed to transport the spinning cutting blade across the surface. The configuration to harness Energy 1 to simultaneously generate motion across the surface (via Energy 2) via automatic counter-rotation across the mowing surface plane is an improvement in the orbital deck mower disclosed in U.S. Pat. No. 11,058,052.

The instant invention makes use of the thrust derived from the airflow generated by lawn mower blades to create and control actual useful kinetic motion of the cutting device (i.e., mower) along defined degrees of freedom of the cutting device versus using the airflow solely for motion of the grass clippings (i.e., lifting/transporting/circulating/disposing of the grass clippings), which is the current primary use of the airflow generated by lawn mower blades. Specific uses of thrust include dynamically controlling vertical position above the surface, tangential thrust providing Energy 2 in orbital configuration (see discussion of adding louvered shell/covers over the motor/blades to allow airflow to be directed to provide Energy 2 below), stabilizing thrust to balance the mowing device on uneven ground and thrust-based actuation/motion of mowing arms (if properly configured).

In U.S. Pat. No. 11,058,052, inherent motor/mower blade angular momentum is harnessed to generate useful kinetic motion of the mower. The present invention harnesses inherent mower blade airflow/thrust to cause useful kinetic motion of the device. One could compare the combined usage of motor/blade angular momentum and thrust to the fundamental operation and control of UAV drones (e.g., quadcopters). A quadcopter propeller simultaneously acts as a thruster (i.e., to lift) and flywheel for angular momentum (to control yaw rotation about the z-axis). This basic configuration, when supplemented by advanced motors, lithium batteries, advanced materials, and software are useful in controlling the device. The present invention is directed to traversing a grass surface versus flying in the air (but may fly or levitate in some circumstances).

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

### PARTS LIST

10 mower
12 mower frame
G ground
14 front wheels
16 rear wheels
18 mower handle
20 power source or battery
22 electric motor
24 motor/blade assembly
26 spring or springs
28 mower blade or blades
29 shaft
Hₘₐₓ maximum height
T downward thrust
Hₘᵢₙ minimum height
W weight
F force/elastic strain
30 rotating turret
32 treads
34 orbital shaft
36 spring hinge
Θ angle
38 male appendage
40 female slot
42 fixed slotted plate or tube
44 sleeve
46 cover
48 vents
A airflow

1. A vegetation cutting device comprising:
a frame configured to be supported for movement in relation to a supporting surface,
at least one motor/blade assembly supported in relation to the frame, the motor/blade assembly comprising a motor, and a blade supported for rotational movement in relation to the motor, the blade being curved to provide airflow thrust to produce at least one of vertical motion of the blade or orbital motion of the blade.

2. The vegetation cutting device according to claim 1, further comprising at least one spring supported in fixed relation to the device, the at least one motor/blade assembly being supported in relation to the at least one spring.

3. The vegetation cutting device according to claim 2, wherein the device is an orbital deck mower comprising a turret, the at least one spring being fixed in relation to one end of an arm having an opposing end that is supported in relation to the turret.

4. The vegetation cutting device according to claim 3, wherein the arm is one of a plurality of arms supported in spaced relation to the turret, the at least one spring is one of a plurality of springs each supported in relation to one of the plurality of arms, and the at least one motor/blade assembly is one of a plurality of motor/blade assemblies each supported in relation to one of the plurality of springs.

5. The vegetation cutting device according to claim 3, further comprising a cover for each one of the plurality of motor/blade assemblies, the cover comprising a vented opening comprising angled louvers that deflect thrust-based airflow and generate orbital rotation of the turret.

6. The vegetation cutting device according to claim 3, further comprising a pivoting mechanism configured to rotate the at least one arm to tilt the at least one motor/blade assembly at an angle to provide a thrust component to rotate the turret.

7. The vegetation cutting device according to claim 6, further comprising an electric motor to control the pivoting mechanism to control the rotation of the at least one arm and the tilt of the at least one arm.

8. The vegetation cutting device according to claim 6, wherein the blade is curved to produce thrust to move the arm up and down.

9. The vegetation cutting device according to claim 6, wherein the pivoting mechanism comprises a spring hinge to both suspend the arm at a predetermined height when the device is in a powered OFF position and oppose downward thrust when the device in a powered ON position.

10. The vegetation cutting device according to claim 9, wherein the pivoting mechanism rotates the arm to tilt the arm as the arm moves up and down via a slot and pin mechanism.

11. A vegetation cutting device comprising:
a deck,
one or more springs supported in fixed relation to the deck,
one or more motor/blade assemblies, the one or more springs being sized and configured to support the one or more motor/blade assemblies in relation to the deck, the one or more motor/blade assemblies each comprising a curved blade and an electric motor for rotating the curved blade, and
a battery supported in relation to the mower deck and connected to the electric motor of each one of the one or more motor/blade assemblies by flexible wires to transmit power to the electric motor of each one of the one or more motor/blade assemblies,
wherein the one or more springs are sized to suspend a known weight of the one or more motor/blade assemblies at a predetermined maximum ground clearance height when the device is in a Power Off mode and have spring constants to allow maximum spring extension of the one or more springs to a minimum ground clearance when the device is in a Power On mode, and
wherein the one or more motor/blade assemblies, when in the Power On mode, generate thrust to create suction at the vegetation.

12. The vegetation cutting device according to claim 11, further comprising a spacer/caster below the center of the motor/blade assembly to guard against blade-to-ground contact.

13. The vegetation cutting device according to claim 11, wherein the deck is an orbital deck comprising a turret, the one or more springs being fixed in relation to one end of a corresponding one of one or more arms having an opposing end that is supported in relation to the turret.

14. The vegetation cutting device according to claim 13, wherein the one or more arms comprises a plurality of arms supported in spaced relation to the turret, the one or more springs comprises a plurality of springs each supported in relation to one of the plurality of arms, and one or more motor/blade assemblies comprises a plurality of motor/blade assemblies each supported in relation to one of the plurality of springs.

15. The vegetation cutting device according to claim 13, further comprising a cover for each one of the plurality of motor/blade assemblies, the cover comprising a vented opening comprising angled louvers that deflect thrust-based airflow and generate orbital rotation of the turret.

16. The vegetation cutting device according to claim 13, further comprising one or more pivoting mechanisms each configured to rotate a corresponding one of one or more arms to tilt a corresponding one of the one or more motor/blade assemblies at an angle to provide a thrust component to rotate the turret.

17. The vegetation cutting device according to claim 16, wherein the one or more pivoting mechanisms each comprises a spring hinge to both suspend a corresponding one of the one or more arms at a predetermined height when the device is in the Power OFF mode and oppose downward thrust when the device in the Power ON mode.

18. The vegetation cutting device according to claim 17, wherein the one or more pivoting mechanisms rotates the one or more arms to tilt the one or more arms as the one or more arms each move up and down via a slot and pin mechanism.

19. A method of vegetation cutting device comprising the steps of:
a) providing a device comprising at least one motor/blade assembly supported for orbital movement in relation to the device,
b) operating the at least one motor/blade assembly to produce thrust,
c) harnessing the thrust of the motor/blade assembly to produce orbital motion of the motor/blade assembly.

20. The method according to claim 19, wherein the motor/blade assembly comprises curved blades tilted at an angle.
